(19) United States
(12) Patent Application Publication
(10) Pub. No.: US 2017/0250562 A1
(43) Pub. Date: Aug. 31, 2017

(54) Combined RF Charging And Communication Module and Methods of Use

(71) Applicant: Humavox, Ltd., Kfar-Saba (IL)

(72) Inventor: Asaf Manova-Elssibony, Ramat Gan (IL)

(73) Assignee: Humavox, Ltd., Kfar-Saba (IL)

(21) Appl. No.: 15/516,176

(22) PCT Filed: Oct. 6, 2015
(86) PCT No.: PCT/IL2015/050992

§ 371 Date: Mar. 31, 2017

Related U.S. Application Data
(60) Provisional application No. 62/058,115, filed on Oct. 1, 2014.

(51) Int. Cl. H02J 7/02; H01Q 1/24

(52) U.S. Cl. CPC H02J 7/025; H01Q 1/248; H04L 67/12

(57) ABSTRACT

The invention is directed to a combined communication and charging module for a wireless rechargeable device configured to allow RF charging and data transceiving in an adjacent/identical frequency is provided. The combined communication and charging module comprising a charging unit and a communication unit, both units are sharing a common antenna, wherein the operation of said units is performed alternately and determined by an environmental effect and/or by filtering of signals received according to their strength. The environmental effect in the context of the present invention is the presence or absence of a wireless charging device and the creation of a charging zone in the surroundings of said combined communication and charging module such that said common antenna is within or outside said charging zone.

### CROSS-REFERENCE TO RELATED APPLICATION

The present PCT application claims priority to U.S. provisional patent application 62/058,115 filed 01 Oct. 2014, entitled “Combined RF Charging System and Communication System”, the filing date and full disclosures of which is incorporated herein by reference in their entirety.

### TECHNOLOGICAL FIELD

The subject matter disclosed herein is related to solutions for coexistence of wireless RF charging unit together with a communication unit in a manner that safe operation of the two units in similar/identical frequencies is allowed, and further, that the two units share common structures such as antenna. More particularly, the invention is directed to a combined communication and charging module configured to be incorporated within a wireless rechargeable device.

### BACKGROUND

Wireless charging is a relatively new arena that still requires adaptation of various sub-systems and units within the device to be charged in order to obtain an efficient charging process and yet, not to damage other components within the wireless rechargeable device (also denoted hereinafter as: “device under charge (DUC)” during the charging process.

For example, when charging in high level transmission values of RF energy, a communication unit within the device under charge may receive some of the transmitted power for charging and consequently may be damaged. The invention in one aspect provides a solution for such a scenario.

Another leading trend in the technological world of today that requires attention is the miniaturization of things as well as the connectivity of daily products to smart devices known as the “Internet Of Things”. For this purpose, electrical circuits and communication abilities should be implemented within daily used products in a manner that minimal changes with the structure of the product will be made. In order to efficiently assemble the electrical component, and further to save space there is an attempt to use common components for different units/modules. The invention in a further aspect provides a solution for this need by providing a combined charging and communication module in which, the charging unit and the communication unit are sharing a common antenna. The common antenna is configured to operate as an RF antenna so as to allow charging of the electronic device and also to operate as a data communication antenna so as to allow transmission of data to the surroundings and receiving of data from the surroundings. Such combination is not a trivial matter as operation of both units in similar/identical frequencies may cause damage to the communication unit/module that is configured to operate in substantially lower power levels.

Attempts to combine charging unit/module with a communication unit/module are known in the art. Such attempts are disclosed in the following patent applications: WO 2015022450, WO 2013172530, US 2015042170, and US 2014210276.

Thus, in one aspect, the invention is aimed to provide a combined communication and charging module with two units sharing a common antenna, and configured to operate in adjacent/identical frequency band. The combined module is configured and operable to allow normal functioning of the communication unit and prevent damages that may occur to said unit in high level transmission values during charging. By sharing electrical components and providing them at least dual functionality within the chargeable device, contribute to reduce cost and save limited space.

In another aspect, the invention is aimed to provide a power filter that is configured and operable to filter the received signals according to their power levels.

### SUMMARY

In accordance with one aspect of the invention, there is provided a novel combined charging and communication module comprising at least a charging unit and a communication unit sharing a common antenna, both units are configured to operate in adjacent/identical frequency band. The combined charging and communication module is configured to be integrated in a rechargeable device (DUC) in order to allow the DUC wireless recharging and communication abilities while minimizing the production costs and the space required for integrating such separated modules.

The charging unit, also denoted interchangeably in the text below: “RF power receiving unit”, “RX power” and “Rxp” is configured to receive high level RF power signals from the common antenna and to rectify the signals to a DC voltage for charging the DUC upon positioning of the DUC in a suitable surroundings for charging i.e. within or onto a wireless charging device in a manner that the DUC is within a charging zone. Wireless charging devices as well as the created charging zone is described in details in our PCT applications, published as WO2013/179284, and WO2015/022690 the contents of which are incorporated herein by reference.

The communication unit, also denoted interchangeably in the text below: “data transiving unit”, “data communication unit”, “TRX Data” and “T_{RXD}” is configured to allow the DUC communication abilities i.e. transmitting and receiving data from and to the surroundings. The components of the communication unit are configured to operate in low power level signals since high power levels may cause damage to the communication circuit. Thus, in order to allow proper and safe functioning of the combined module it is important to functionally separate between the two units. The present invention provides a dual level of isolation solution. First by the environment surrounding the DUC and further by a power filter sorting the received signal by its power level.

The environmental effect on the isolation of the units happens as the reflected impedance of the common antenna in the combined module is influenced by the environmental condition and changes according to the surroundings of the DUC, wherein the DUC may be positioned in a free space setup or it may be positioned within a wireless charging device (when the charging device is a close or semi-close chamber) or onto the wireless charging device (when the charging device is designed as a charging surface).

By “Free space set up”, we mean that the antenna impedance is not influenced by the surroundings and met the required condition for receiving and transmitting electromagnetic radiation without the influence of a charging zone boundaries, i.e. that the DUC is positioned outside of a charging zone.

In one embodiment of the invention a combined communication and charging module for a wireless rechargeable device, said module is configured to allow RF charging and data transceiving in an adjacent/identical frequency is provided. The combined communication and charging module comprising a charging unit and a communication unit, both units are sharing a common antenna, wherein the operation of said units is performed alternately and determined by an environmental effect and/or by filtering of signals received according to their strength.

The “environmental effect” in the context of the present invention is the presence or absence of a wireless charging device and the creation of a charging zone in the surroundings of said combined communication and charging module such that said common antenna is within or outside said charging zone.

The presence of said common antenna within said charging zone functionally affects the impedance of said common antenna to match with the impedance of the charging unit and to allow wireless charging of the rechargeable device, and further to mismatch with the impedance of the communication unit to limit/attenuate signals reception by the communication unit within the charging zone.

The absence of a charging zone in the surroundings of said common antenna affects the impedance of said common antenna to match with the impedance of the communication unit and to allow data transceiving, and further to mismatch with the impedance of said charging unit and to limit/attenuate signals reception by the charging unit.

In some embodiments, the filtering of signals received according to their strength is obtained by a novel power filter that is functionally attached to the common antenna and to said charging and communication units, wherein said power filter is configured to pass the signals received either to the communication unit or to the charging unit according to a predetermined power levels such that low power signals suitable for communication are being passed to the communication unit, while high power signals suitable for charging are being passed to the charging unit.

In the absence of a charging zone in the surroundings of said common antenna the power filter is configured to pass low power signals from said common antenna to said communication unit by matching the operation range impedance of said communication unit to the impedance of said common antenna. Alternatively, in the presence of a charging zone in the surroundings of said common antenna said power filter is configured to pass high power signals from said common antenna to said charging unit by matching the operation range impedance of said charging unit to the impedance of said common antenna.

The present invention is further directed to a rechargeable device comprising a combined communication and charging module according to the above described embodiments.

Yet, the invention is also directed to a power filter configured to selectively pass signals according to their power level to a communication unit or to a charging unit sharing a common signals source in a combined charging and communication module of a rechargeable device, said power filter is configured to pass low power signals received by matching between the impedance of the operation range of said communication unit to the impedance of the common signal source, and further to pass high power signals received by matching between the impedance of the operation range of said charging unit to the impedance of the common signals source. In a specific embodiment, the impedance of the common signals source is constant (i.e. is not being changed by the power level of the signal).

The invention is further directed to a method for enabling RF wireless charging and data transceiving in adjacent/identical frequency band of a wirelessly rechargeable device having a combined communication and charging module according to the above description, said method comprising the following steps: (a) positioning said wirelessly rechargeable device away from a charging zone so as to allow said common antenna to operate as a communication antenna; and (b) positioning said wirelessly rechargeable device within/onto a wireless charging device so as to allow said common antenna to operate as a RF charging power receiving antenna.

### BRIEF DESCRIPTION OF THE DRAWINGS

Examples illustrative of embodiments of the disclosure are described below with reference to drawings attached hereto. The accompanying drawings, which are incorporated in and constitute a part of this specification, show certain aspects of the subject matter disclosed herein and, together with the description, help explain some of the principles associated with the disclosed implementations. In the drawings, identical structures, elements or parts that appear in more than one figure are generally labeled with the same numeral in all the drawings in which they appear. Dimensions of components and features shown in the drawings are generally chosen for convenience and clarity of presentation and are not necessarily shown to scale. Many of the figures presented are in the form of schematic illustrations and, as such, certain elements may be drawn greatly simplified or not-to-scale, for illustrative clarity. The drawings are listed below.

FIG. 1A is a schematic diagram illustrating major components of a combined communication and charging module having RF power unit and high level communication unit sharing a common antenna, said module is integrated within a DUC in a free space setup.

FIG. 1B is a schematic diagram illustrating the impedances reflected from the combined module units illustrated in FIG. 1A: the reflected impedance of the RF power receiving unit Z_{RXP}, the reflected impedance of the communication unit Z_{TRXD}, and the reflected impedance of the common antenna Z_{CANT}, all in a free space setup.

FIGS. 1C, 1D and 1E are Smith charts illustrating the impedance of the data communication antenna Z_{TRXD}, the RF power unit Z_{RXP}, and the common antenna Z_{CANT} respectively, in the free space setup illustrated in FIG. 1A.

FIG. 1F and 1G are graphs illustrating the units return loss S33 and S22 of the communication unit T_{RXD} and the RF power receiving unit R_{XP} respectively, in the free space setup of FIG. 1A.

FIG. 1H and 1I are graphs illustrating the insertion loss S31 between the communication module T_{RXD} and the common antenna C_{ANT}, and the insertion loss S21 between the RF power receiving unit R_{XP} and the common antenna C_{ANT} respectively, in the free space setup of FIG. 1A.

FIG. 2A is a schematic diagram illustrating the DUC of FIG. 1A with the combined communication and charging module sharing a common antenna positioned in the vicinity or within a wireless charging device having RF power transmitting unit (within a charging zone setup).

FIG. 2B is a schematic diagram illustrating the impedances reflected from the RF power transmitting antenna Z_{TXA} and the power transmitter Z_{TXP} of the transmitting unit, and the impedances reflected from the common antenna Z′C_{ANT}, the RF receiving unit Z_{RXP}, and the communication unit Z_{TRXD} in the new setup illustrated in FIG. 2A.

FIGS. 2C, 2D and 2E are Smith charts illustrating the impedance of the data communication antenna Z_{TRXD}, the impedance of the RF power unit Z_{RXP}, and the impedance of the common antenna Z′C_{ANT} of FIG. 2B respectively, when the DUC is within the charging zone.

FIG. 2F and 2G are graphs illustrating the units return loss S33 and S22 of the data communication unit T_{RXD} and the RF power receiving unit R_{XP} respectively, while in the vicinity or within a charging device (within a charging zone setup).

FIGS. 2H and 2I are graphs illustrating the insertion loss S31 and S21 between the common antenna C_{ANT} and the data communication unit T_{RXD}, and between the common antenna C_{ANT} and the RF power receiving unit R_{XP} respectively, when the DUC is within the charging zone setup.

FIG. 3A is a schematic diagram illustrating major components of a combined communication and charging module integrated within a DUC, wherein the combined module comprises RF receiving power unit R_{XP} and a communication unit T_{RXD} sharing a common antenna connected to a Power filter in a free space setup.

FIG. 3B is a schematic diagram illustrating the impedance reflected from the units illustrated in FIG. 3A in a free space set-up, wherein Z_{CANT} is the impedance reflected from the common antenna, Z_{PF} is the impedance of the power filter when the received signal power level is in the range of (−85) to (−10) dbm, Z_{TRXD} is the impedance of the data communication unit, and Z_{RXP} is the impedance reflected from the RF power receiving unit.

FIGS. 3C, 3D and 3E are Smith charts illustrating the impedances of the data communication unit Z_{TRXD}, the RF power unit Z_{RXP}, and the common antenna Z_{CANT} respectively, in the free space setup illustrated in FIG. 3A.

FIG. 3F and 3G are graphs illustrating the return loss S33 and S22 of the communication unit T_{RXD} and the RF power receiving unit R_{XP} respectively, in the free space setup of FIG. 3A, wherein the additional effect of the power filter (solid line) over the environmental effect (dotted line) is shown.

FIGS. 3H and 3I are graphic illustrations of the insertion loss S31 and S21 in the free space set up of FIG. 3A between the communication unit T_{RXD} and the Common antenna C_{ANT} connected to the power filter, and between the RF power receiving unit R_{XP} and the common antenna C_{ANT} connected to the power filter respectively, wherein the additional effect of the power filter (solid line) over the environmental effect (dotted line) is shown.

FIG. 4A is a schematic diagram illustrating the DUC illustrated in FIG. 3A having a combined communication and charging module sharing a common antenna connected to a power filter, in a charging zone setup, i.e. when the DUC is positioned in the vicinity or within a charging device having RF power transmitting module, in a manner that at least the common antenna is positioned within a charging zone.

FIG. 4B is a schematic diagram illustrating the impedance reflected from the components illustrated in FIG. 4A, wherein Z_{TXA} and Z_{TXP} are the impedances of reflected from the RF transmitting antenna and from the power transmitter of the RF transmitting unit, Z′C_{ANT} is the impedance reflected from the common antenna connected to the power filter, Z′pf is the impedance reflected from the power filter while the received signal power is in the range of (0) to (40) dbm, Z_{RXP} is the impedance reflected from the RF receiving unit, and Z_{TRXD} is the impedance reflected from the communication unit, all in the setup illustrated in FIG. 4A within the charging zone.

FIGS. 4C, 4D and 4E are Smith charts illustrating the impedances of the data communication unit Z_{TRXD}, the RF power receiving unit Z_{RXP}, and the common antenna Z′C_{ANT} of FIG. 4B respectively in the charging zone set up.

FIG. 4F and 4G are graphs illustrating the units return loss S33 and S22 of the data communication unit T_{RXD} and the RF power receiving unit R_{XP} respectively, while in the vicinity of a charging device (dotted lines) and with the additional effect of the power filter (solid lines).

FIGS. 4H and 4I are graphs illustrating the units insertion loss S31 and S21 between the communication unit T_{RXD} and the common antenna C_{ANT}, and between the RF power receiving unit R_{XP} and the common antenna C_{ANT} respectively, while the DUC is positioned in the vicinity or within a charging device (dotted lines), and with the additional effect of the power filter (solid lines).

FIG. 5 is a schematic block diagram of a power filter in accordance with examples of the invention.

FIG. 6 is a schematic illustration of the combined communication and charging module with the power filter of FIGS. 3 and 4 showing the impedance behavior of the power filter, the communication unit and the charging unit depending on the power level of the received signal.

FIG. 7 is a graphical illustration showing a dual level isolation effect between the communication unit and the charging unit of the combined module achieved by a first isolation by the environment in the surroundings of the DUC containing the combined module and, by a second isolation achieved by the power filter of the invention that functionally enables the two units to operate in a similar or identical frequencies and to share a common antenna without damaging the communication unit while charging.

### DETAILED DESCRIPTION

The subject matter disclosed herein is directed to a combined charging and communication module sharing a common antenna that is configured to be incorporated within a wireless rechargeable device wherein, the charging unit is configured and operable to allow normal functioning of the communication unit and prevent damages that may occur in high power level transmission values. This may be achieved by designing the combined module in a manner that the impedance of the common antenna changes in correlation with the changes in the environment setup, in which the rechargeable device is positioned. Upon changing the location of the rechargeable device from a free space setup to a charging device setup, the impedance of the common antennas changes in a manner that the antenna is matched/mismatched to the communication unit/charging unit so as to prevent damages that may occur to the communication unit at high power levels.

The invention is further directed to a novel power filter that is configured to improve the impedance match of the units according to the power levels of the received signals and to allow a dual isolation between the units in the combined module although they share a common antenna and configured to operate in an adjacent/identical frequency band.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

Thus, in one embodiment of the invention a combined communication and charging module for a wireless rechargeable device configured to allow RF charging and data transceiving in an adjacent/identical frequency is provided. The combined communication and charging module comprising a charging unit and a communication unit, both units are sharing a common antenna, wherein the operation of said units is performed alternately and determined by an environmental effect and/or by filtering of signals received according to their strength.

The invention is also directed to a novel power filter configured to selectively pass signals according to their power level either to a communication unit or to a charging unit sharing a common signals source in a combined charging and communication module of a rechargeable device, the power filter is configured to pass low power signals received by matching between the impedance of the operation range of said communication unit to the impedance of the common signal source, and further to pass high power signals received by matching between the impedance of the operation range of said charging unit to the impedance of the common signals source.

The invention is further directed to a method for enabling RF wireless charging and data transceiving in adjacent/identical frequency band of a wirelessly rechargeable device having a combined communication and charging module according to the above, said method comprising the following steps: (a) positioning said wirelessly rechargeable device away from a charging zone so as to allow said common antenna to operate as a communication antenna; and (b) positioning said wirelessly rechargeable device within/onto a wireless charging device so as to allow said common antenna to operate as a RF charging power receiving antenna.

Following is a description, by way of example only and with reference to the accompanying figure which are a diagrammatic representation, of one method of carrying the current subject matter into effect.

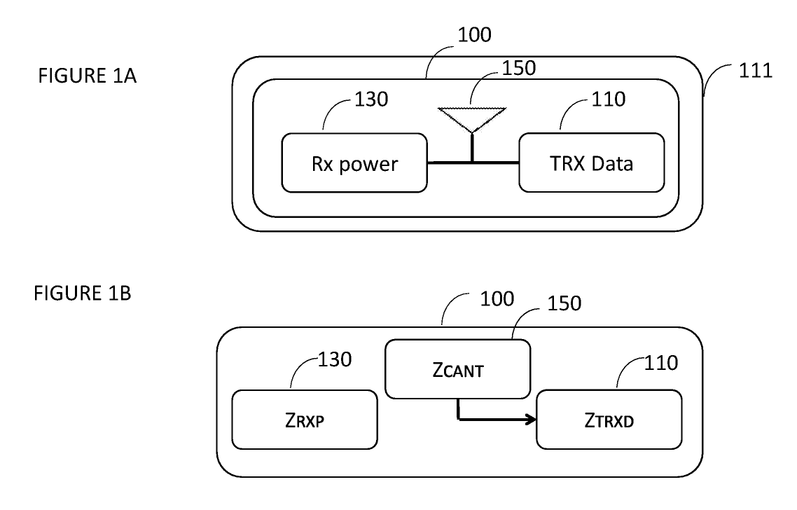

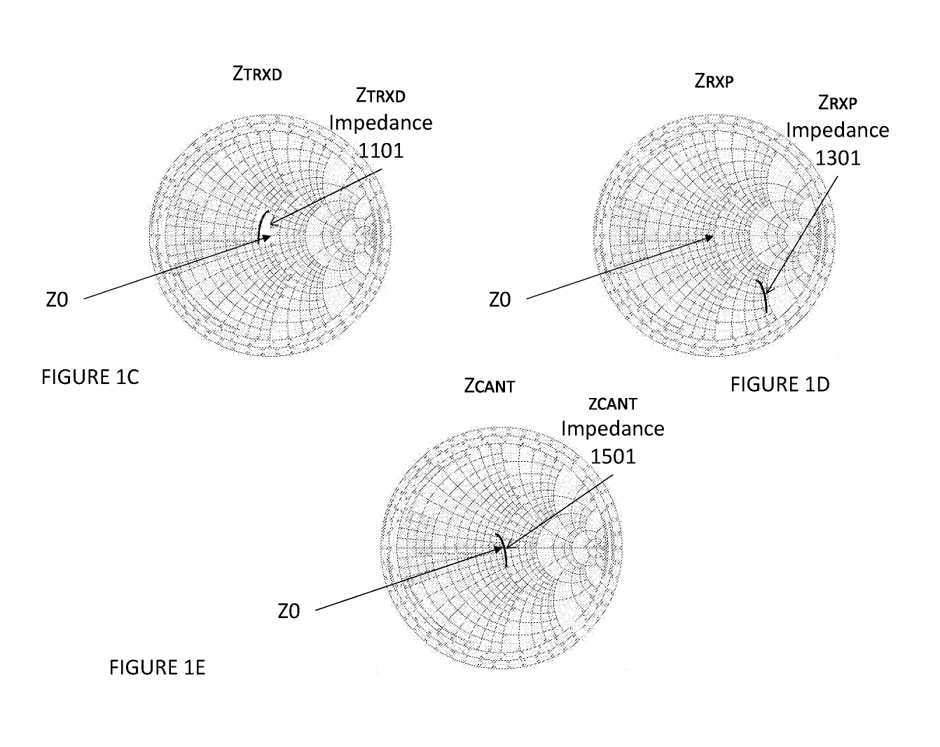

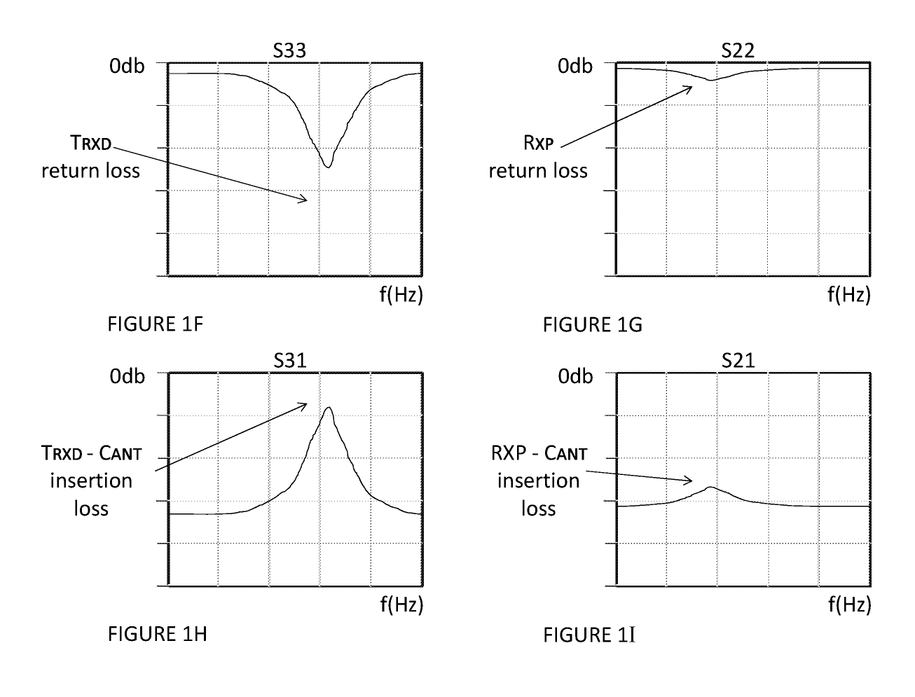

FIG. 1A-1I describe a free space setup of a combined module having RF charging unit and communication unit sharing a common antenna, integrated in a DUC, wherein the common antenna is configured to serve as a communication antenna and as a receiving charging power antenna in a similar/identical frequencies.

FIG. 1A is a schematic diagram illustrating major components of a combine communication and charging module 100 having RF power receiving unit 130 and high level communication unit 110 sharing a common antenna 150, wherein the combined module 100 is configured to be integrated within a wireless chargeable device 111. Common antenna 150 is configured to function as a communication antenna and to receive and transmit data to and from the transceiving unit 110 and further to serve as the receiving antenna and to deliver RF power to the power receiving unit 130 according to the environmental conditions it the surroundings of DUC 111, i.e. depending on the presence or absence of a wireless charging device and a functional charging zone.

In the setup illustrated in this figure, the DUC 111 is positioned in a free space setup. The condition of the common antenna and the reflected impedance of each one of the component in this setup is illustrated in FIG. 1B. As shown in the figure, in a free space setup, the data transceiving unit 110 Z_{TRXD} is matched to the impedance of the common antenna Z_{CANT} and reflecting impedance Z_{TRXD}, while the RF power receiving unit 130 is unmatched to the common antenna and reflecting impedance Z_{RXP}. In this situation no charging occurs and the DUC may only receive and transmit data.

This condition is graphically illustrated by the Smith charts of FIGS. 1C-1E. Transceiving unit 110 in this setup is matched to the common antenna and thus, the transceiving unit impedance Z_{TRXD} 1101 is close to Z0 as shown on the Smith chart as a curve positioned near the center point Z0 of the Smith chart meaning proper data transfer (FIG. 1C). At the same setup, the RF power receiving unit 130 is located outside a charging zone and therefore, this unit is unmatched to the common antenna 150. In this set up the receiving unit impedance Z_{R XP} 1301 is not equal to Z0 and indicated as a curve positioned away from the center point Z0 of the Smith chart meaning that no power is received by the power receiving unit (FIG. 1D). The impedance of common antenna Z_{CANT} 1501 is Z0 as illustrated in FIG. 1E. In this setup, the common antenna is matched to the data transceiving unit (the communication unit) and thus, Z_{CANT} is represented on the Smith chart as a curve positioned at the center point Z0 of the Smith chart meaning the common antenna impedance is matched to the communication unit impedance and that proper data transfer occurs between the antenna and the communication unit.

FIGS. 1F and 1G are graphs illustrating the return loss values in the matched and unmatched conditions of the communication unit and the power receiving unit respectively in a free space setup for a given frequency band, i.e., when the DUC is positioned outside of a charging zone. In this setup, the value and pattern obtained for the communication unit T_{RXD} return loss S33 (db) indicates match condition between the transceiver of the communication unit and the common antenna meaning that negligible amount of the incident power is being reflected back. In contrast, the power receiving unit R_{XP} return loss S22 value is close to 0 db and the pattern obtained indicates unmatched condition meaning that most of the incident power received from the common antenna is reflected back. Thus, in free space the common antenna functionally operates as a communication antenna and no substantial charging is enabled.

FIG. 1H and 1I are graphs illustrating the insertion loss S31 between the communication unit T_{RXD} and the common antenna C_{ANT}, and the insertion loss S21 between the RF power receiving unit R_{XP} and the common antenna CANT respectively, in the free space setup of FIG. 1A. In this setup, most of the power received from the antenna is delivered to the communication unit and thus, the insertion loss value is minimal (close to 0 db). As such, the insertion loss S21 value between the RF power receiving unit R_{XP} and the common antenna C_{ANT} is relatively high since only negligible power received from the common antenna is delivered to the power receiving unit and most of the power is reflected back to the antenna.

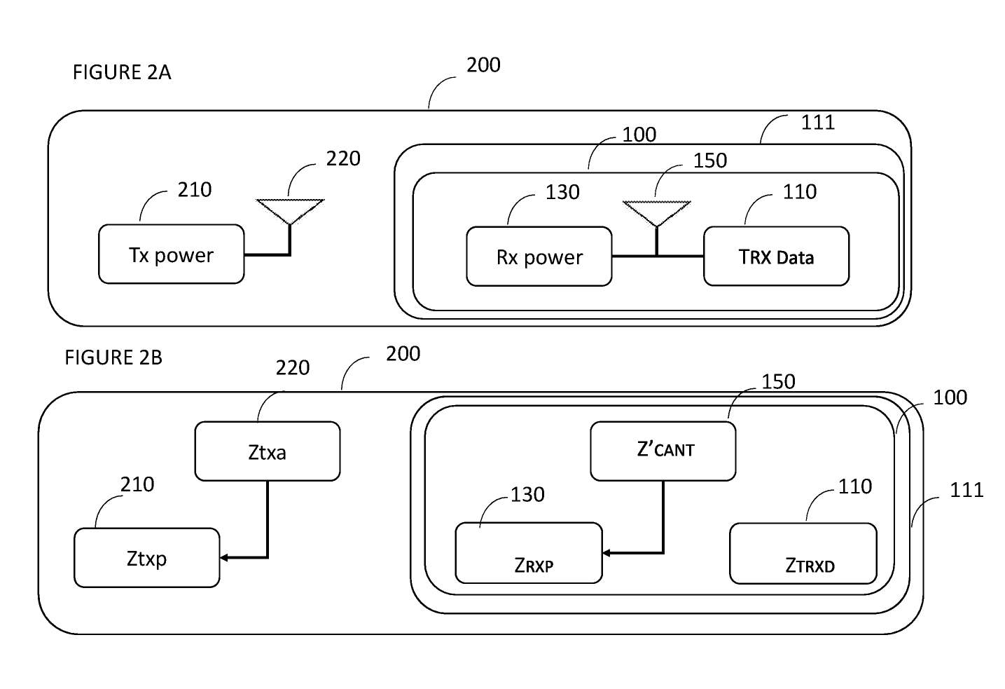

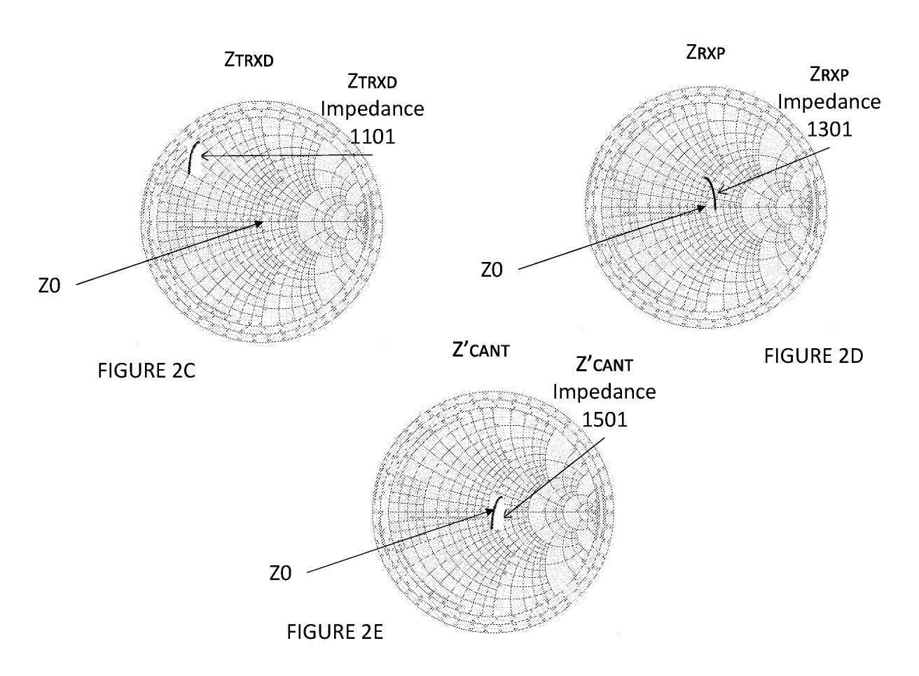

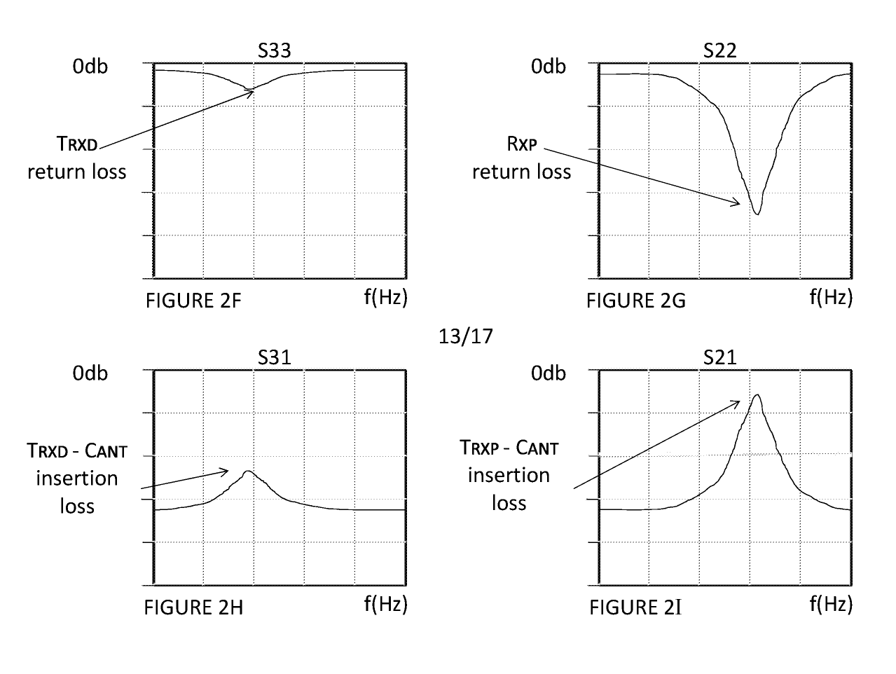

FIG. 2A illustrate the DUC 111 of FIG. 1A having the combined communication and charging module 100 comprising a data communication unit and RF power receiving unit sharing a common antenna, in a setup where the DUC 111 is positioned within or onto a wireless charging device 200 depending on the structure and the shape of charging device 200 if it is a closed, semi closed compartment or a surface. In this setup, DUC 111 is positioned within the charging zone in a proximity to transmitting unit 210 and transmitting antenna 220.

The new setup affects the impedances reflected from the components as illustrated in FIG. 2B. In such condition, the impedance of transmitting unit (Ztxa of the transmitting antenna 220 and Ztxp of the transmitter 210) is matched to transmit RF power. The impedance of the common antenna 150 changes to Z′C_{ANT} and it is now matched to the impedance reflected from the RF power receiving unit Z_{RXP} as both antennas, the common antenna and the RF Power transmitting antenna, are within the charging zone and coupling between them occurs. At this setup, the common antenna 150 functions as a receiving antenna and charging may occur. At this setup, the impedance reflected from the communication unit 110 Z_{TRXD} is in an unmatched condition with the common antenna 150, thus no transmission of data or receipt of data to and via common antenna 150 is possible.

This condition is graphically illustrated by the Smith charts of FIGS. 2C-2E, wherein Z_{TRXD} 1101 indicates the impedance of communication unit 110; Z_{RXP} 1301 indicates the impedance of RF power receiving unit 130; and Z′C_{ANT} 1501 indicates the impedance of common antenna 150 within a charging zone. In this setup, Z_{TRXD} 1101 is far from the center point Z0 of the Smith chart indicating that the communication unit is unmatched to the common antenna, while the RF power receiving unit 130 and common antenna 150 are matched. The reflected impedance Z_{RXP} 1501 of the RF power receiving unit is shown on the Smith chart as curve that is placed near the center point Zo of the charts indicating good match condition and the reflected impedance of the common antenna Z′C_{ANT} 1301 is shown on the Smith chart as a curve that is placed on the center point Zo of the chart indicating match conditions. The position of the curves on the Smith chart mean that there is a proper power transfer from the common antenna 150 to the power receiving unit 130 and negligible power transfer to the communication unit 110 as it is unmatched to the common antenna at this setup.

FIG. 2F and 2G illustrate the return loss values of the communication unit 130 and the receiving unit 110 respectively according to the unmatched and match conditions for the given frequency band in the setup of FIG. 2A. In this setup, the value and pattern obtained for the communication unit T_{RXD} return loss S33 (db) indicate unmatched condition between the data transceiving unit and the common antenna. Therefore, most of the incident power at this setup is reflected back and no data is transmitted or received by the DUC. In contrast, the receiving unit R_{XP} return loss S22 value (db) and pattern reflects matching condition between the common antenna and the power receiving unit meaning that a negligible amount of the incident power is being reflected back and that receiving RF power for charging is possible.

FIG. 2H and 2I are graphs illustrating the insertion loss S31 between the communication unit T_{RXD} and the common antenna C_{ANT}, and the insertion loss S21 between the RF power receiving unit R_{XP} and the common antenna CANT respectively, in the charging zone setup of FIG. 2A. In this setup, most of the power received from the antenna is delivered to the RF power receiving unit and thus, the insertion loss S21 value is high (close to 0 db). As such, the insertion loss S31 value between the communication unit T_{RXD} and the common antenna C_{ANT} is relatively high since only negligible power received from the common antenna is delivered to the communication unit and most of the power is reflected back to the antenna.

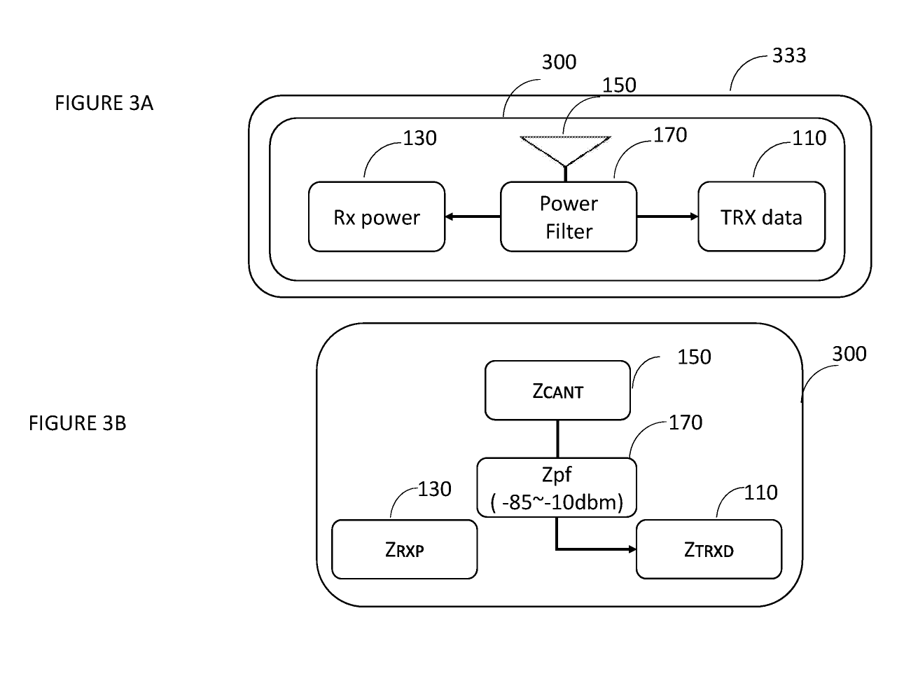

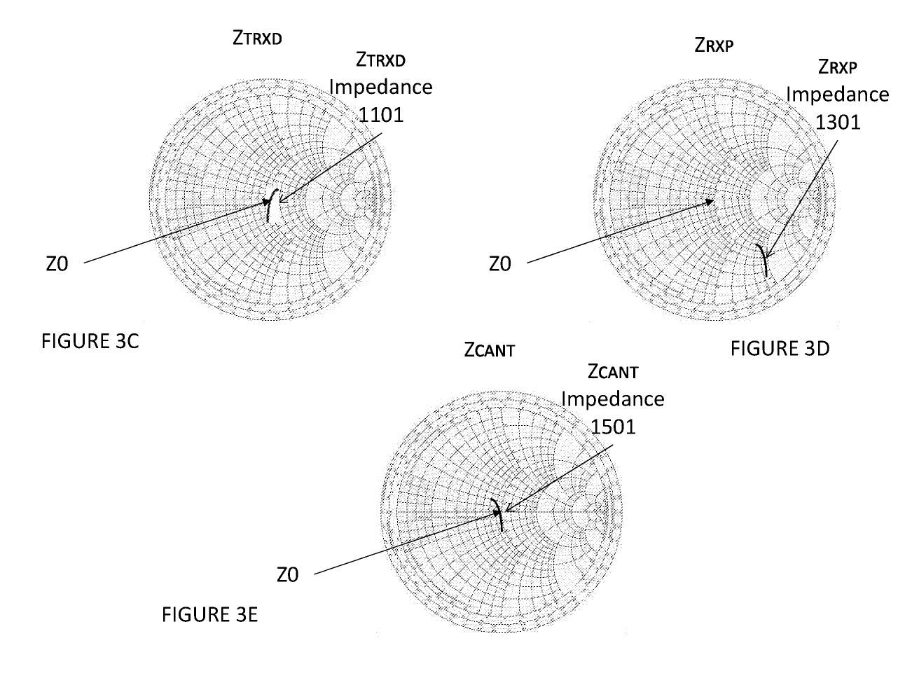

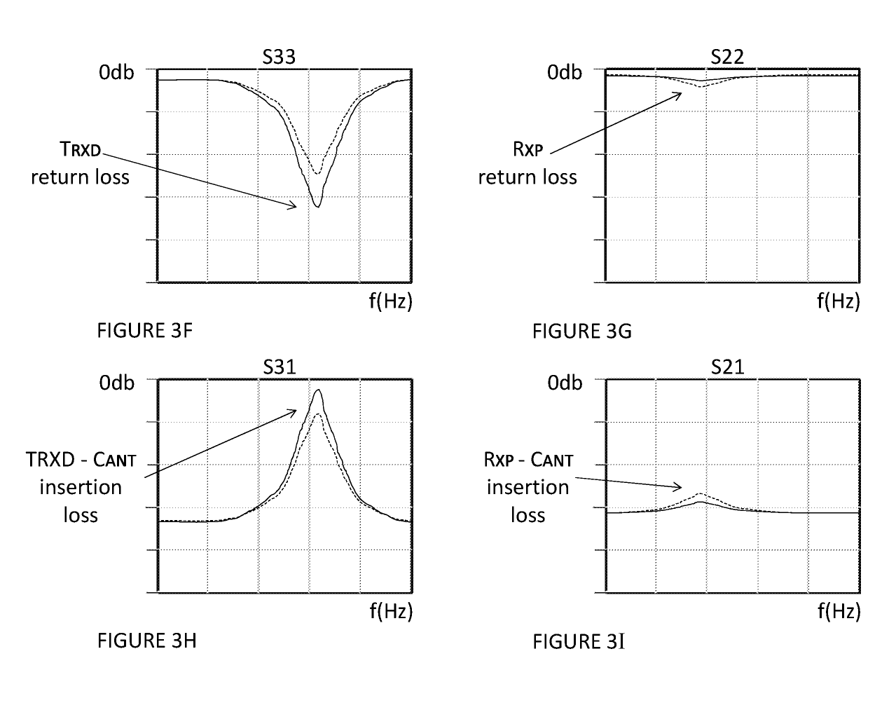

FIG. 3A is a schematic illustration of one another optional implementation of the subject matter wherein, a combined communication and charging module 300 comprises RF power unit R_{XP}, a high level communication unit T_{RX} Data sharing a common antenna while the units are connected to the common antenna via a Power Filter, in a free space setup.

The novel power filter 300 provided herein is configured to filter the received signal according to its power level. In this manner, low power signals received by the common antenna are directed to the communication unit 110, while high power signals received by the common antenna 150 are directed to the RF power receiving unit 120. By this filtering, the power filter functionally isolate between the communication and the charging unit although both are connected to the same antenna and operate in a similar or adjacent frequency band. This functional isolation allow the co-existence of the two units and the sharing of common components without causing any harm to the communication unit that could have happen due to exposing of the unit to high power signals that are suitable for charging. A detailed description of the operation mode and characters of the power filter of the invention are provided with reference to FIGS. 5-7 hereinbelow. Similar to the combined module 100 of FIGS. 1 and 2, the combined module 300 is also configured and operable to be assembled in a device under charge 333.

FIG. 3B is a schematic diagram illustrating the impedance reflected from the units illustrated in FIG. 3A in a free space setup, wherein Z_{CANT} is the impedance reflected from the common antenna 150, Z_{PF} is the impedance of the power filter 170 when the received signal power level is in the range of (−85) to (−10) dbm, Z_{TRXD} is the impedance of the data communication unit 110, and Z_{RXP} is the impedance reflected from the RF power receiving unit 130.

This condition is graphically illustrated by the Smith charts of FIGS. 3C-3E. The data communication unit 110 in this setup is matched to the common antenna 150 and thus, the curve denoting the reflected impedance Z_{TRXD} 1101 is positioned on the center point Z0 of the Smith chart meaning optimal data transfer (FIG. 3C). The optimal match is achieved by the dual level isolation effect between the communication and the charging unit obtained by the environmental condition (free space setup) and further by the power filter. At the same setup, the RF power receiving unit 130 is located outside a charging zone and therefore, this unit is unmatched to the common antenna 150. Thus, in this setup the reflected impedance of the RF power receiving unit Z_{RXP} 1301 is not equal to Z0 and indicated as a curve positioned away from the center point Z0 of the Smith chart meaning that only negligible power is received by the power receiving unit (FIG. 3D). The reflected impedance of common antenna Z_{CANT} 1501 is equal to Z0 as illustrated in FIG. 3E. In this setup, the common antenna 150 is perfectly matched to the data transceiving unit (the communication unit) and thus, Z_{CANT} is represented on the Smith chart as a curve positioned at the center point Z0 of the Smith chart, meaning that proper data transfer occurs between the common antenna and the communication unit.

FIG. 3F and 3G are graphs illustrating the return loss S33 and S22 of the communication unit T_{RXD} and the RF power receiving unit R_{XP} respectively, in the free space setup of FIG. 3A, wherein the additional effect of the power filter 170 (solid line) over the environmental effect (dotted line) on the impedance matching of the unit comprised in the combined module is shown.

In these graphs, the values and pattern obtained for the communication unit T_{RXD} return loss S33 (db) indicate good match between T_{RXD} and the common antenna in the environmental condition of a free space setup (dotted line) that is further improved by the power filter that allows only passage of low power signals in the free space setup, meaning that negligible amount of the incident power is being reflected back. In contrast, the power receiving unit R_{XP} return loss S22 value is close to 0 db and following the power filter effect it is even closer to 0 db as the filter prevents high power signals to pass through. The pattern obtained indicates unmatched condition meaning that almost all the incident power received from the common antenna is reflected back. Thus, in free space the common antenna functionally operates as a communication antenna and no charging is enabled and the power filter functionally improves the matched and the unmatched conditions within the units of the combined module.

FIG. 3H and 3I are graphic illustrations of the insertion loss S31 and S21 in the free space set up of FIG. 3A between the communication unit T_{RXD} and the common antenna C_{ANT} connected to the power filter, and between the RF power receiving unit R_{XP} and the common antenna C_{ANT} connected to the power filter respectively, wherein the addition of the power filter (solid line) over the environmental effect (dotted line) improves the transmission between the common antenna and the data communication unit. Most of the power received from the antenna is delivered to the communication unit and thus, the insertion loss value is minimal (close to 0 db). The insertion loss S31 value even decreases following the power filter effect that functionally enables, in the free space setup, only low power signals to pass. Thus, the values obtained are even closer to 0 db (solid line) compared to the values obtained without the power filter (dotted line). As a result, the insertion loss S21 value between the RF power receiving unit R_{XP} and the common antenna C_{ANT} is relatively high (dotted line) and further increases by the operation of the power filter (solid line), since only negligible power received from the common antenna is delivered to the power receiving unit and almost all of the power received is reflected back to the antenna.

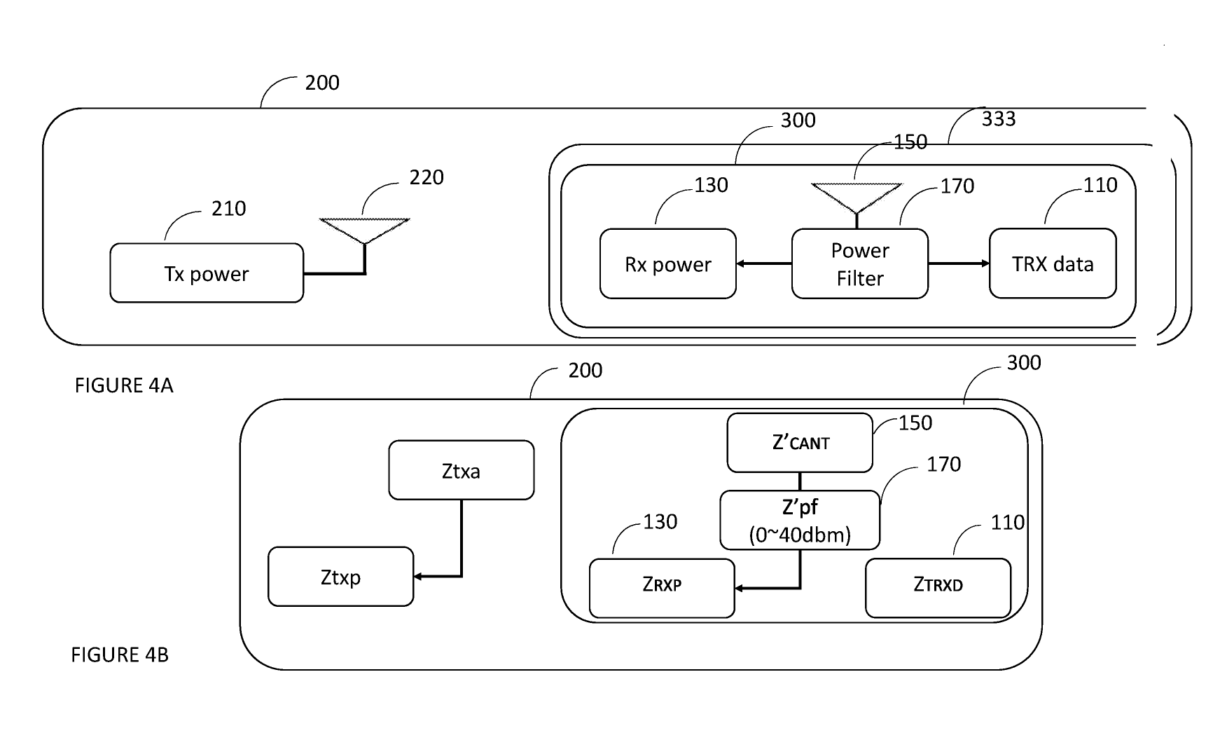

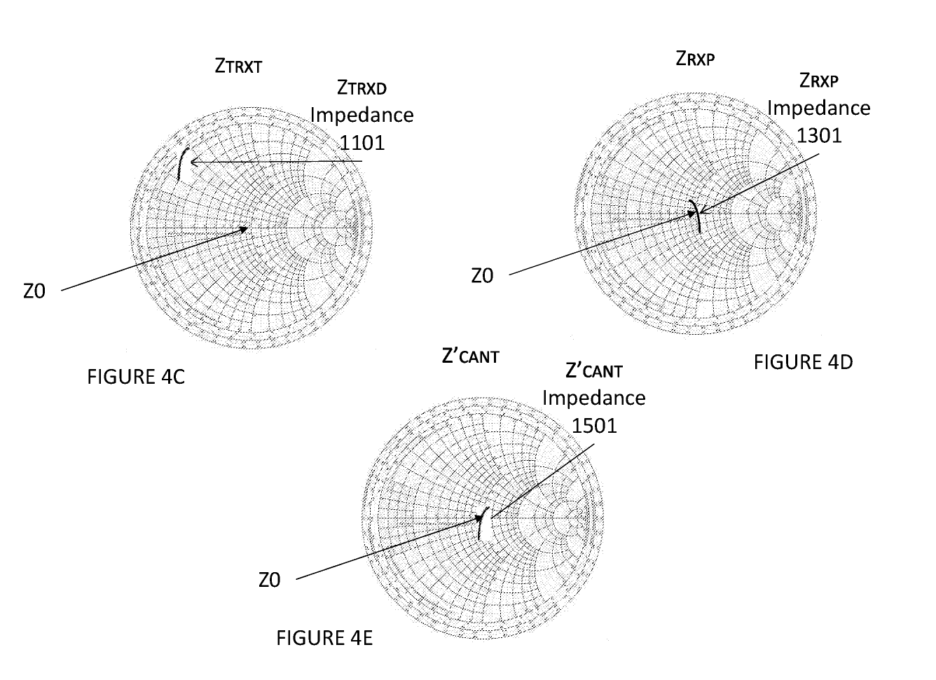

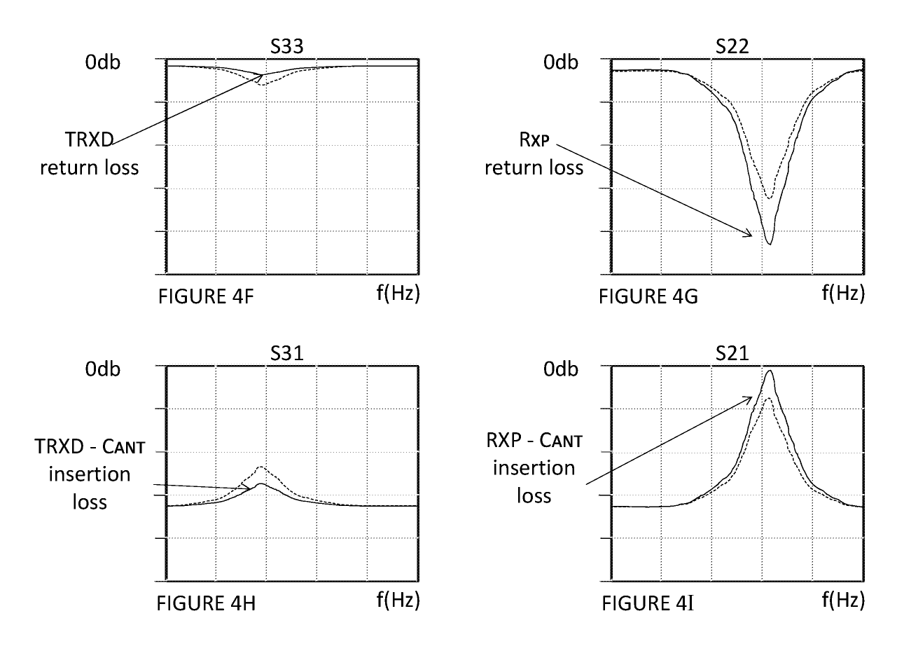

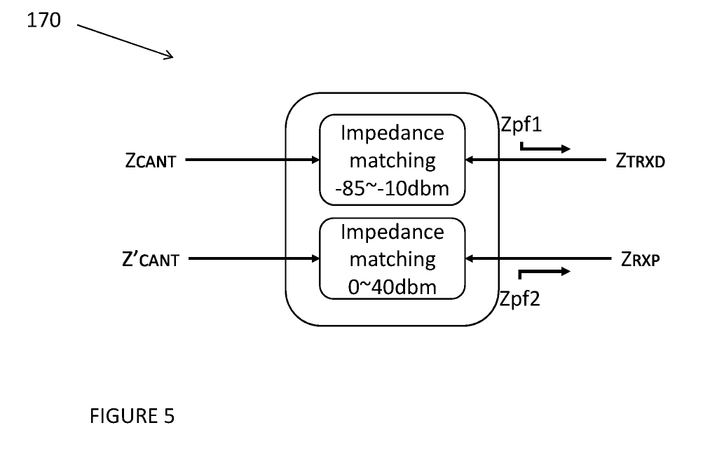

FIG. 4A is a schematic diagram illustrating the reflected impedances of the combined communication and charging module 300 with the power filter upon changing the environmental conditions of the DUC comprising said module and positioning the DUC within a wireless charging device (when the charging device is a close or semi close chamber), or onto a wireless charging device (when the charging device is a surface). In this setup, since the charging device comprises RF power transmitting module a charging zone is created that effect the impedance of the common antenna and consequently the operation mode of the module, as will be described in details below.

FIG. 4A is a schematic block diagram of the major components relevant in this setup including wireless charging device 200 comprising transmitting antenna 220 and Tx power transmitter 210, a DUC 333 positioned within/onto wireless charging device 200 and comprising combined communication and charging module 300 containing a common antenna 150 connected to power receiving unit Rx 130 and to data receiving unit T_{RX} Data 110 via a power filter 170. The impedance reflected from the components above are illustrated in FIG. 4B, wherein Z_{TXA} and Z_{TXP} are the impedances reflected from the RF transmitting antenna and from the power transmitter of the RF transmitting unit respectively, Z′C_{ANT} is the impedance reflected from the common antenna while connected to the power filter, Z′pf is the impedance reflected from the power filter while the received signal power is in the range of (0) to (40) dbm, Z_{RXP} is the impedance reflected from the RF receiving unit, and Z_{TRXD} is the impedance reflected from the communication unit, all in the charging zone setup.

At this setup the power filter is matched with the RF power receiving unit and as such, high power level signals (in the range of 0-40 dbm) are directed only to this unit. Concurrently, since the communication unit is in an unmatched condition with power filter 170, the received power is not directed to it by the filter and as a result, the communication unit is protected from possible damage that the high power signals received may cause to its electrical components.

The impedance match and unmatched of the units in this setup is further illustrated in FIGS. 4C-4E showing Smith charts illustration. In these charts, the reflected impedance of the data communication unit Z_{TRXD} 1101 is denoted by a curve positioned away from the center of the chart Z0, reflecting an unmatched condition between this unit and the common antenna meaning that no communication is possible in this setup. The reflected impedance of the RF power receiving unit Z_{RXP} 1301, and the reflected impedance of the common antenna Z′C_{ANT} 1501 are perfectly matched as both curves are positioned in the center of the chart equal to Z0, meaning that the common antenna efficiently delivers the received RF high power signals to the Rx power receiving unit. The position of the curve 1301 of the Rx power receiving unit at the center of the chart reflects the optimization of the impedance match between the unit thanks to the power filter connected between them that while in the charging zone setup it selectively allows only high power level signals to pass through.

FIG. 4F and 4G are graphs illustrating the return loss values S33 and S22 of the data communication unit T_{RXD} and the RF power receiving unit R_{XP} respectively, while in the charging zone setup (dotted lines) and with the additional effect of the power filter (solid lines). In the charging zone setup, the value and pattern obtained for the communication unit T_{RXD} return loss S33 (db) indicate unmatched condition between the data transceiving unit and the common antenna. Therefore, most of the incident power at this setup is reflected back (dotted line). The addition of the power filter between the communication unit and the common antenna that selectively allows passage of high power level signals in this setup, further increases the return loss S33 as the value obtained is close to 0 db (solid line). In contrast, the receiving unit R_{XP} return loss S22 value (db) and pattern reflect good match between the common antenna and the power receiving unit (dotted line) that is further being improved by the selectivity of the power filter, meaning that a negligible amount of the incident power is being reflected back and that RF power receiving for charging is possible in the charging zone setup.

FIG. 4H and 4I are graphs illustrating the insertion loss S31 and S21 values between the communication unit T_{RXD} and the common antenna C_{ANT}, and between the RF power receiving unit R_{XP} and the common antenna C_{ANT} respectively, while the DUC comprising the units is positioned in the vicinity or within the charging device (dotted lines), and with the additional effect of the power filter (solid lines). As shown, most of the power received from the antenna is delivered to the RF power receiving unit and thus, the insertion loss S21 value is maximal (close to 0 db) and it is further improved with the additional selectivity of the power filter. On the contrary, the insertion loss S31 value between the communication unit T_{RXD} and the common antenna C_{ANT} is relatively high since only negligible power received from the common antenna is delivered to the communication unit (dotted line) and it is further increased by the operation of the power filter (solid line) as most of the power received by the antenna is delivered via the filter to the charging unit and the rest of the received signal is reflected back due to unmatched condition between the communication unit and the power filter and the communication unit and the common antenna while positioned within the charging zone.

FIG. 5 is a schematic block diagram illustrating the operation region of power filter 170 in accordance with examples of the invention. In the example illustrated herein, power filter 170 comprises at least two predesigned impedance matching blocks Zpf1 and Zpf2. The first block having impedance matching Zpf1 is configured to operate in power levels between (−85) dbm to (−10) dbm. At these power levels, Zpf1 is matched to the impedance of the common antenna Z_{CANT} in a free space setup and also to the impedance reflected from the communication unit. Thus signals received from the antenna in this power level range may pass through the filter toward the communication unit to allow data transfer. The second block having impedance matching Zpf2 is configured to operate in power levels between (0) dbm to (40) dbm. At these power levels, Zpf2 is matched to the impedance of the common antenna Z′C_{ANT} in a charging zone setup, and also to the impedance reflected from the Rx power receiving unit. Thus signals received from the antenna in this power level range may pass through the filter toward the Rx power unit to allow charging of the DUC.

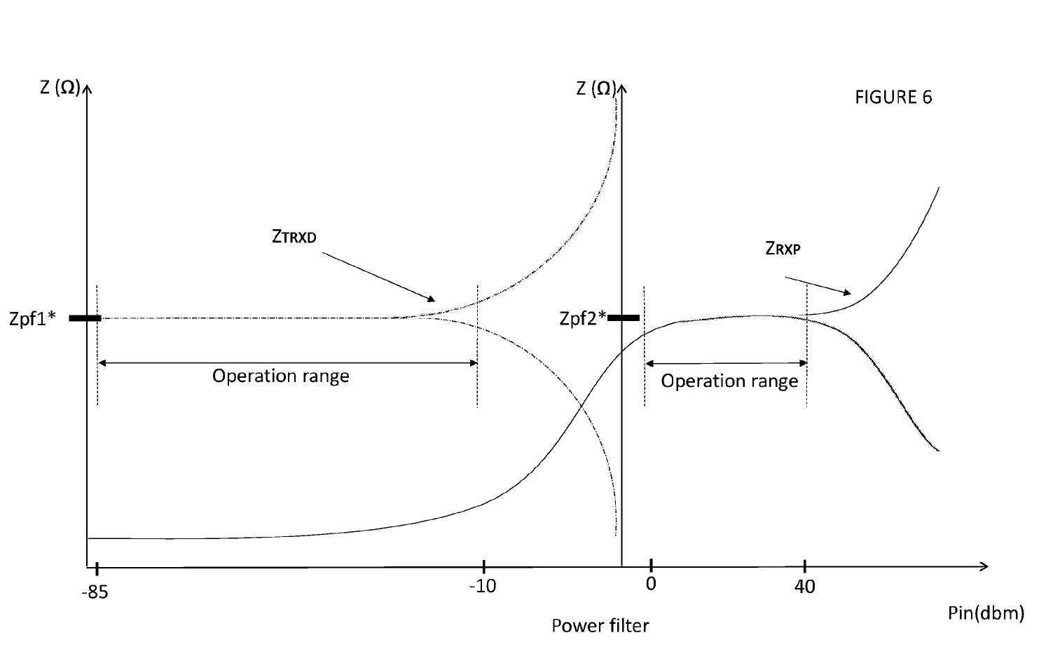

FIG. 6 is a graphic illustration of the impedance of the power filter, the communication unit, and the charging unit according to the power levels of the received signal (dbm). As both units are configured to operate in adjacent/identical frequencies, in order to obtain a good communication ability and also efficient wireless charging to the DUC, the impedance of each of the communication unit and the Rx power receiving unit should be matched to the impedance of the common antenna according to the power level of the received signals, in addition to the impedance match/un-match of the units as a result of the environmental effects on the unit's impedance (free space setup or charging zone setup) as described in details with reference to FIGS. 1-5 above.

In the specific example illustrated herein, the conjugate impedance of the power filter terminal Zpf1* is configured to be matched to the impedance of the communication unit Z_{TRXD} in low power levels between the range of (−85) to (−10) dbm in free space setup. This range is the operation range of the communication unit and thus, the power filter is matched to it, shown as a single dotted line. When the power level of the received signal rises above (−10) db, the communication unit exceeds its operation range, thus its impedance Z_{TRXD} is being dramatically changed and unmatched condition occurs. In that situation the communication unit is unmatched to Zpf1*.

At the range of (−85) to (−10) dbm the Rx power receiving unit is unmatched to the power filter and only when the power level of the received signal rises, the conjugate impedance of the power filter Zpf2* is matched to the reflected impedance of the Rx power receiving unit in the charging zone setup. The matched condition occurs in the range between (0) dbm to (40) dbm, which is the operation range of Z_{RXP} shown as a single solid line. When the power level of the received signal rises above (40) db the charging unit exceeds its operation range, thus its impedance Z_{RXP} is being dramatically changed and unmatched condition occurs. In that situation the charging unit is unmatched to Zpf2*.

In a single isolation mode, where the environment in the surroundings of the DUC is constant (i.e. no environmental changes occur), the impedance of the signal source is constant, the impedances Zpf1* equals Zpf2* and the isolation depends solely on the filtering operation of the power filter according to the match and unmatched condition of the communication unit and the power receiving unit operation ranges.

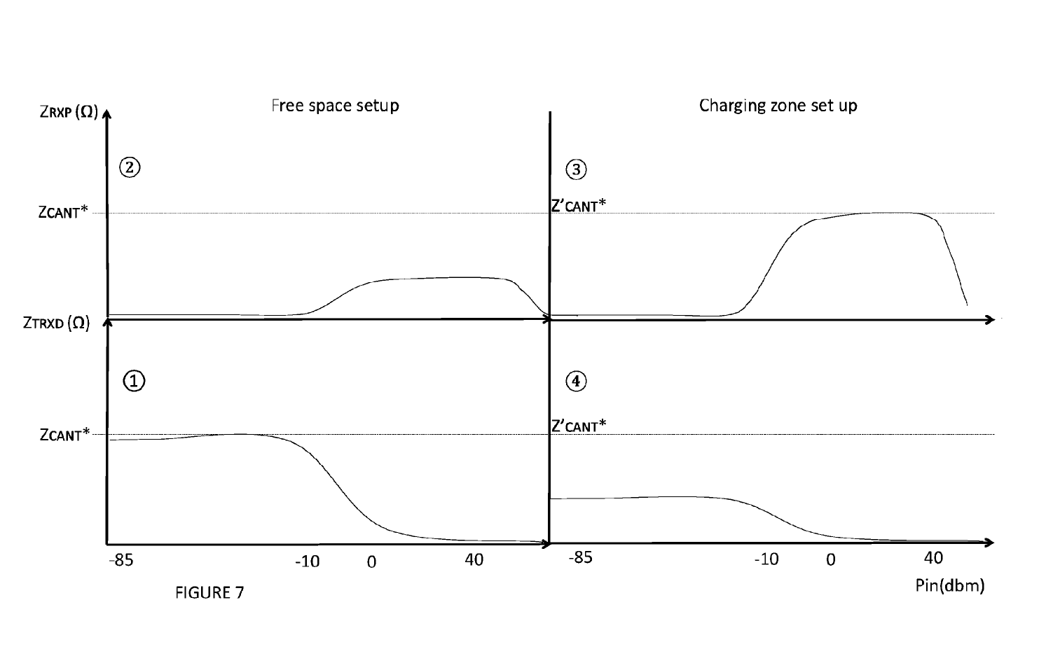

FIG. 7 is a graphical illustration summarizing the dual isolation effect between the communication unit and the charging unit of the combined module of the invention, although both units are sharing a common antenna and operate in adjacent/identical frequency band. The graph is divided to four sub-graphs illustrating the impedance changes (Y axis) of the different components of the combined module with the power filter according to the power level of the received signal (X axis), in two setups: a free space setup; and inside/onto a charging device (a charging zone setup).

In the free space setup (graphs \textcircled{1}\textcircled{2}) the reflected impedance of the data communication unit Z_{TRXD} is matched to the conjugate impedance of the common antenna Z_{CANT}* as long as the power level of the received signal is in the range of (−85) to (−10) dbm (graph \textcircled{1}). In this range, maximal match is achieved and optimal data communication may occur. When the power level of the received signal increases at the same setup, the impedance Z_{TRXD} of the communication unit changes, and is no longer matched to the conjugate impedance Z_{CANT}* of the common antenna unit.

When the power level of the received signal is in the range of (0) to (40) dbm (graph \textcircled{2}), the impedance of the Rx power receiving unit Z_{RXP} changes but yet remains unmatched to the conjugate impedance Z_{CANT}* as the DUC is not inside/onto a charging device (i.e. not within a charging zone) and the impedance change of the R_{XP} unit is obtained only due to the filtering operation of power filter.

When the environmental setup changes (graphs \textcircled{3}\textcircled{4}) and the DUC is positioned within or onto a wireless charging device (within a charging zone), the match between the conjugate impedance of the common antenna and the Rx Power receiving unit is high (Z_{RXP}=Z′_{CANT}*) as long as the received signal power is in the range of (0) to (40) dbm.

Within the charging zone setup, when the power level of the received signal is in the range of (−85) to (−10) dbm the impedance of the receiving power unit changes and no match between the Rx power receiving unit and the conjugate impedance of the common antenna occurs.

The impedance of the communication unit Z_{TRXD} in this range, also changes but yet remains unmatched to the conjugate impedance Z′_{CANT}* as the DUC is inside/onto a charging device (i.e. within a charging zone) and the impedance change of the communication unit is obtained only due to the filtering operation of power filter (graph \textcircled{4}).

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A combined communication and charging module for a wireless rechargeable device configured to allow radio frequency (RF) charging and data transceiving in an adjacent/identical frequency, said combined communication and charging module comprising a charging unit and a communication unit, both units are sharing a common antenna, wherein the operation of said units is performed alternately and determined by an environmental effect and/or by filtering of signals received according to their strength.

2. The combined communication and charging module according to claim 1, wherein said environmental effect is the presence or absence of a wireless charging device and the creation of a charging zone in the surroundings of said combined communication and charging module such that said common antenna is within or outside said charging zone.

3. The combined communication and charging module according to claim 2, wherein the presence of said common antenna within said charging zone functionally affects the impedance of said common antenna to match with the impedance of the charging unit and to allow wireless charging of a rechargeable device, and further to mismatch with the impedance of the communication unit to limit/attenuate signals reception by the communication unit.

4. The combined communication and charging module according to claim 2, wherein the absence of a charging zone in the surroundings of said common antenna affects the impedance of said common antenna to match with the impedance of said communication unit and to allow data transceiving, and further to mismatch with the impedance of said charging unit and to limit/attenuate signals reception by the charging unit.

5. The combined communication and charging module according to claim 1, wherein said filtering of signals received according to their strength is obtained by a power filter functionally attached to said common antenna and to said charging and communication units, wherein said power filter is configured to pass the signals received either to the communication unit or to the charging unit according to a predetermined power levels such that low power signals suitable for communication are being passed to said communication unit, while high power signals suitable for charging are being passed to said charging unit.

6. The combined communication and charging module according to claim 5, wherein in the absence of a charging zone in the surroundings of said common antenna said power filter is configured to pass low power signals from said common antenna to said communication unit by matching the operation range impedance of said communication unit to the impedance of said common antenna.

7. The combined communication and charging module according to claim 5, wherein in the presence of a charging zone in the surroundings of said common antenna said power filter is configured to pass high power signals from said common antenna to said charging unit by matching the operation range impedance of said charging unit to the impedance of said common antenna.

8. The combined communication and charging module of claim 1, wherein said combined communication and charging module is used in a rechargeable device.

9. (canceled)

10. (canceled)

11. A method for enabling radio frequency (RF) wireless charging and data transceiving in adjacent/identical frequency band of a wirelessly rechargeable device having a combined communication and charging module of claim 1, said method comprising:
a. Positioning said wirelessly rechargeable device away from a charging zone so as to allow said common antenna to operate as a communication antenna; and
b. Positioning said wirelessly rechargeable device within/onto a wireless charging device so as to allow said common antenna to operate as a RF charging power receiving antenna.

12. A system for a wireless rechargeable device configured to allow radio frequency (RF) charging and data transceiving in an adjacent/identical frequency, said system comprising:
the combined communication and charging module of claim 1;
a power filter; and
a common antenna to the combined communication and charging module;
wherein said power filter is functionally attached to the common antenna and to said charging and communication units.

13. The system of claim 12, wherein said power filter is configured to pass the signals received either to the communication unit or to the charging unit according to a predetermined power levels such that low power signals suitable for communication are being passed to the communication unit, while high power signals suitable for charging are being passed to the charging unit.

14. The system of claim 12 wherein said power filter is configured to selectively pass signals according to their power level to a communication unit or to a charging unit sharing a common signals source in a combined charging and communication module of a rechargeable device.

15. The system of claim 12 wherein said power filter is configured to pass low power signals received by matching between the impedance of the operation range of said communication unit to the impedance of the common signal source, and further to pass high power signals received by matching between the impedance of the operation range of said charging unit to the impedance of the common signals source.

16. The system of claim 15, wherein the impedance of said common signals source is constant.

17. The system of claim 12, wherein said environmental effect of the combined communication and charging module is the presence or absence of a wireless charging device and the creation of a charging zone in the surroundings of said combined communication and charging module such that said common antenna is within or outside said charging zone.

18. The system of claim 17, wherein the presence of said common antenna within said charging zone of the combined communication and charging module functionally affects the impedance of said common antenna to match with the impedance of the charging unit and to allow wireless charging of a rechargeable device, and further to mismatch with the impedance of the communication unit to limit/attenuate signals reception by the communication unit.

19. The system of claim 17, wherein the absence of a charging zone of the combined communication and charging module in the surroundings of said common antenna affects the impedance of said common antenna to match with the impedance of said communication unit and to allow data transceiving, and further to mismatch with the impedance of said charging unit and to limit/attenuate signals reception by the charging unit.

20. The system of claim 12, wherein said power filter is functionally attached to said common antenna and to said charging and communication units, wherein said power filter is configured to pass the signals received either to the communication unit or to the charging unit according to a predetermined power levels such that low power signals suitable for communication are being passed to said communication unit, while high power signals suitable for charging are being passed to said charging unit.
